(19) United States
(12) Patent Application Publication
(10) Pub. No.: US 2022/0131133 A1
(43) Pub. Date: Apr. 28, 2022

(54) COMPOSITE ELECTRODE FOR ALL-SOLID-STATE SECONDARY BATTERY

(71) Applicant: ELECTRONICS AND TELECOMMUNICATIONS RESEARCH INSTITUTE, Daejeon (KR)

(72) Inventors: Ju Young KIM, Sejong (KR); Young-Gi LEE, Daejeon (KR); Seok Hun KANG, Daejeon (KR); Dong Ok SHIN, Sejong (KR); Myeong Ju LEE, Daejeon (KR); Kwang Man KIM, Daejeon (KR); Jimin OH, Daejeon (KR)

(21) Appl. No.: 17/511,084

(22) Filed: Oct. 26, 2021

(30) Foreign Application Priority Data
Oct. 26, 2020 (KR) 10-2020-0139538
Feb. 9, 2021 (KR) 10-2021-0018436

(51) Int. Cl. H01M 4/36; H01M 4/38; H01M 4/587; H01M 4/62

(52) U.S. Cl. CPC H01M 4/364; H01M 4/386; H01M 10/052; H01M 4/623; H01M 4/625; H01M 4/587

(57) ABSTRACT

Provided is a composite electrode for an all-solid-state secondary battery including a first active material and a second active material, wherein the first active material and the second active material include different materials from each other, and the content of the first active material is 50 vol % to 98 vol % based on the total volume of the first active material and the second active material, the first active material has a volume change rate of 0 vol % to 30 vol % according to volume expansion/contraction during a charging/discharging process, and the second active material has a volume change rate of 35 vol % to 1000 vol % according to volume expansion/contraction during a charging/discharging process.

### CROSS-REFERENCE TO RELATED APPLICATIONS

This U.S. non-provisional patent application claims priority under 35 U.S.C. § 119 of Korean Patent Application Nos. 10-2020-0139538, filed on Oct. 26, 2020, and 10-2021-0018436, filed on Feb. 9, 2021, the entire contents of which are hereby incorporated by reference.

### BACKGROUND

The present disclosure herein relates to a composite electrode for an all-solid-state secondary battery including two or more types of active materials having different mechanical and electrochemical properties from each other.

Compared to other batteries, a lithium secondary battery has a high energy density and can be made small and light, and thus, is highly likely to be used as a power source for a mobile electronic device and the like. The lithium secondary battery exhibits a high storage capacity, excellent charging/discharging properties, and high processability compared to other energy storage devices such as a capacitor, a fuel cell, and the like, and thus, is receiving great attention as a next-generation energy storage device for a wearable device, an electric vehicle, an energy storage system, and the like.

The lithium secondary battery may include a positive electrode, a negative electrode, and an electrolyte. Typically, as a liquid electrolyte, a carbonate-based solvent in which a lithium salt (LiPF₆) is dissolved is used. A liquid electrolyte has high mobility of lithium ions, and thus, exhibits excellent electrochemical properties. However, there is a problem with safety due to an explosion caused by the high flammability, volatility, and leakage of the liquid electrolyte.

Therefore, research is underway on an all-solid-state secondary battery using a solid electrolyte instead of a liquid electrolyte. An all-solid-state secondary battery may ensure stability and mechanical strength, and thus, is attracting attention in various application systems that require high stability, such as electric vehicles, energy storage systems, wearable devices, and the like.

### SUMMARY

The present disclosure provides a composite electrode for an all-solid-state secondary battery having a high capacity.

The present disclosure also provides an all-solid-state secondary battery including a composite electrode for an all-solid-state secondary battery having a high capacity.

The problems to be solved by the inventive concept are not limited to the above-mentioned problems, and other problems that are not mentioned may be apparent to those skilled in the art from the following description.

An embodiment of the inventive concept provides a composite electrode for an all-solid-state secondary battery including a first active material and a second active material, wherein the first active material and the second active material include different materials from each other, and the content of the first active material is 50 vol % to 98 vol % based on the total volume of the first active material and the second active material, the first active material has a volume change rate of 0 vol % to 30 vol % according to volume expansion/contraction during a charging/discharging process, and the second active material has a volume change rate of 35 vol % to 1000 vol % according to volume expansion/contraction during a charging/discharging process.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a cross-sectional view showing an all-solid-state secondary battery including a composite electrode for an all-solid-state secondary battery according to an embodiment of the inventive concept;

FIG. 2 is a conceptual view of a composite electrode for an all-solid-state secondary battery according to an embodiment of the inventive concept;

FIG. 3 is a scanning electron microscope (SEM) image of a composite electrode for an all-solid-state secondary battery according to an embodiment of the inventive concept;

FIG. 4 is an energy dispersive spectroscopy (EDS) image for carbon of a composite electrode for an all-solid-state secondary battery according to an embodiment of the inventive concept;

FIG. 5 is an energy dispersive spectroscopy (EDS) image for silicon of a composite electrode for an all-solid-state secondary battery according to an embodiment of the inventive concept;

FIG. 6 is the result of measuring charging/discharging properties of Example 1;

FIG. 7 is the result of measuring charging/discharging properties of Example 2; and

FIG. 8 is the result of measuring charging/discharging properties of Example 3.

### DETAILED DESCRIPTION

Advantages and features of the inventive concept and methods of accomplishing the same may be understood more readily by reference to the following detailed description of exemplary embodiments and the accompanying drawings. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art to which the inventive concept pertains. The inventive concept will only be defined by the appended claims. The same reference numerals refer to like elements throughout the specification.

The terms used herein are for the purpose of describing embodiments and are not intended to be limiting of the present invention. In the present disclosure, singular forms include plural forms unless the context clearly indicates otherwise. As used herein, the terms “comprises” and/or “comprising” are intended to be inclusive of the stated elements, steps, operations and/or devices, and do not exclude the possibility of the presence or the addition of one or more other elements, steps, operations, and/or devices.

In addition, embodiments described in the present specification will be described with reference to cross-sectional views and/or plan views which are ideal illustrations of the inventive concept. In the drawings, the thickness of films and regions are exaggerated for an effective description of technical contents. Accordingly, the shape of an example may be modified by manufacturing techniques and/or tolerances. Thus, the embodiments of the inventive concept are not limited to specific forms shown, but are intended to include changes in the form generated by a manufacturing process. Thus, the regions illustrated in the drawings have properties, and the shapes of the regions illustrated in the drawings are intended to exemplify specific shapes of regions of a device and are not intended to limit the scope of the inventive concept. Thus, the regions illustrated in the drawings have properties, and the shapes of the regions illustrated in the drawings are intended to exemplify specific shapes of regions of a device and are not intended to limit the scope of the inventive concept.

Unless otherwise defined, terms used in the embodiments of the inventive concept may be interpreted as meanings commonly known to those skilled in the art.

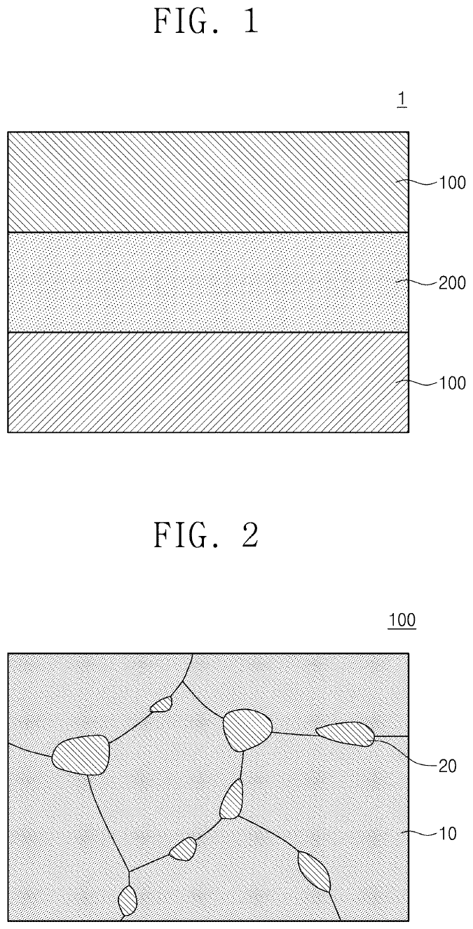

FIG. 1 is a cross-sectional view showing an all-solid-state secondary battery including a composite electrode for an all-solid-state secondary battery according to an embodiment of the inventive concept. FIG. 2 is a conceptual view of a composite electrode for an all-solid-state secondary battery according to an embodiment of the inventive concept.

Referring to FIG. 1 and FIG. 2, an all-solid-state secondary battery 1 according to an embodiment of the inventive concept may include a composite electrode 100 and a solid electrolyte layer 200. Specifically, two composite electrodes 100 may be provided. The composite electrodes 100 may be disposed opposing each other with the solid electrolyte layer 200 interposed therebetween. One of the composite electrodes 100 may be a positive electrode, and the other one of the composite electrodes 100 may be a negative electrode.

At least one composite electrode 100 of the composite electrodes 100 may include a first active material 10 and a second active material 20. In some embodiments, each of the composite electrodes 100 may include the first active material 10 and the second active material 20. In another embodiment, one composite electrode 100 of the composite electrodes 100 may include the first active material 10 and the second active material 20, and the other composite electrode 100 of the composite electrodes 100 may be any one composite all-solid-state electrode including a lithium metal, a lithium-indium composite, or a solid electrolyte. Specifically, the first active material 10 may be formed in the form of a matrix, and the second active material 20 may be formed between the matrix of the first active material 10. As an example, the content of the first active material 10 and the second active material 20 may be 80 wt % to 100 wt % based on the total weight of the composite electrode 100. For the efficient diffusion of lithium ions in the composite electrode 100, the content of the first active material 10 may be greater than the content of the second active material 20. As an example, the content of the first active material 10 may be 50 vol % to 98 vol %, or 65 vol % to 95 vol % based on the total volume of the first active material 10 and the second active material 20. The first active material 10 and the second active material 20 may serve to store lithium ions.

The first active material 10 and the second active material 20 may include different materials from each other. That is, the first active material 10 and the second active material 20 may have different mechanical properties from each other. More specifically, the first active material 10 may be a material which undergoes plastic deformation under pressurization conditions, and the mechanical properties of the second active material 20 may not be limited. In the present disclosure, the plastic deformation may mean structural deformation of a material in a pressurization environment. The plastic deformation of the first active material 10 may significantly contribute to the smooth formation of an interface between the first active material 10 and the second active material 20. Through the interface, lithium ions may move from the first active material 10 to the second active material 20, or from the second active material 20 to the first active material 10. At this time, minimizing pores in the electrode may contribute to smooth lithium ion movement between active materials. For example, the first active material 10 may have a volume change rate of 0 vol % to 30 vol % according to volume expansion/contraction during a charging/discharging process of lithium ions, and the second active material 20 may have a volume change rate of 35 vol % to 1000 vol % according to volume expansion/contraction during a charging/discharging process of lithium ions. At this time, when the first active material 10 has a volume change rate of 0 vol % according to volume expansion/contraction during a charging/discharging process, it may mean that the volume of the first active material 10 is not expanded or contracted during the charging/discharging process, and thus, the volume thereof is maintained. In the present disclosure, a volume change rate according to volume expansion/contraction during a charging/discharging process may mean a rate of change in volume as the volume is expanded or contracted during the charging/discharging process, based on before charging/discharging begins.

As an example, the first active material 10 may include at least one of a carbon-based material and a sulfide-based material. For example, the carbon-based material may include at least one of natural graphite, artificial graphite, carbon nanotubes, carbon oxide nanotubes, graphene, graphene oxide, carbon fiber, amorphous carbon, or highly oriented pyrolytic graphite (HOPG). For example, the sulfide-based material may include at least one of titanium disulfide (TiS2), lithium titanium disulfide, molybdenum disulfide (MoS2), lithium molybdenum disulfide, tungsten disulfide (WS2), lithium tungsten disulfide, iron sulfide (FeS2), lithium iron sulfide, vanadium disulfide (VS2), lithium vanadium disulfide, and LiTi2(PS4)3.

As the composite electrode 100 includes the first active material 10 capable of plastic deformation, the structural deformation of the first active material 10 may be made possible, so that interfaces between molecules in the first active material 10 and/or an interface between the first active material 10 and the second active material 20 may be closely formed. Accordingly, the diffusion of lithium ions in the first active material 10 and the second active material 20 may be efficiently achieved, and the storage and release of the lithium ions in the first active material 10 and the second active material 20 may be facilitated.

In addition, the composite electrode 100 may not include a solid electrolyte. A typical composite electrode for an all-solid-state secondary battery generally includes a solid electrolyte for ion conduction in the composite electrode. However, according to the present invention, as the composite electrode 100 includes the first active material 10, the composite electrode 100 may not include a solid electrolyte.

As an example, the second active material 20 may include at least one of a metal-based material, an oxide-based material, a phosphide-based material, a phosphate-based material, a silicon-based material, or a halogen-based material. For example, the metal-based material may include at least one of Sn, Li, Al, Ag, Bi, In, Ge, Pb, Pt, Ti, Zn, Mg, or Co. For example, the oxide-based material may include at least one of a lithium-nickel-cobalt-aluminum-based oxide (LiNiₓCo_{y}Al_{z}O₂, 0.01≤x≤2, 0.01≤y≤0.30, 0.01≤z≤0.99), a lithium-cobalt-based oxide (LiCoO₂), a lithium-nickel-based oxide (LiNiO₂), a lithium-manganese-based oxide (LiMn₂O₄), a lithium-nickel-cobalt-manganese-based oxide (LiNiₓCo_{y}Mn_{z}O₂, x+y+z=1), a lithium-iron-phosphorus-based oxide (LiFePO₄), a lithium-titanium-based oxide (Li₄Ti₅O₁₂), or a metal oxide. As an example, the metal oxide may include an oxide containing at least one metal among Sn, Li, Al, Ag, Bi, In, Ge, Pb, Pt, Ti, Zn, Mg, and Co. For example, the phosphide-based material may include the lithium-iron-phosphorus-based oxide (LiFePO₄). For example, the phosphate-based material may include the lithium-iron-phosphorus-based oxide (LiFePO₄). For example, the silicon-based material may include at least one of Si, a lithium-silicon alloy, SiN, or SiOₓ (0.01≤x≤2). For example, the halogen-based material may include at least one of AgF, CuF, BiF₃, CuF₂, CoF₃, FeF₃, NiF₂, MnF₃, FeF₂, VF₃, TiF₃, CuCl₂, FeCl₃, or MnCl₂.

In a typical lithium ion secondary battery, excessive volume expansion and contraction are repeated during a charging/discharging process of lithium ions, so that an active material is pulverized. Particularly, when only the second active material 20 having a high energy density is included in a secondary battery, the balance of an electrochemical reaction is broken, so that the implementation capacity of the second active material 20 may rapidly decrease. On the contrary, according to the present invention, the first active material 10 has an energy density somewhat lower than the energy density of the second active material 20, but may exhibit high structural stability during a charging/discharging process, and thus, may exhibit a high capacity retention rate. Therefore, when the second active material 20 is present in a matrix of the first active material 10, the matrix of the first active material 10 ensures the overall structural stability of the composite electrode 100, so that an electrochemical reaction of the second active material 20 may be stably induced, and a decrease in the implementation capacity thereof may be minimized. Meanwhile, in order to avoid a pulverization process caused by volume expansion and contraction, the particle size of the second active material 20 may be adjusted. Generally, an active material having a size of several to hundreds of nanometers may show a strong tendency to pulverization according to volume expansion and contraction, and this effect may appear more reinforced in the matrix of the first active material 10.

As the composite electrode 100 includes the second active material 20 with a high energy density per unit volume, an all-solid-state secondary battery having a capacity may be implemented. However, when the composite electrode 100 includes the second active material 20, due to generally low plastic properties of the second active material 20, interfaces between molecules in the second active material 20 may not be closely formed, and the diffusion of lithium ions in the second active material 20 may not be efficiently achieved.

As described above, according to the present invention, the composite electrode 100 includes both the first active material 10 and the second active material 20, so that an interface between the first active material 10 and the second active material 20 may be closely formed, and the diffusion of lithium ions in the first active material 10 and the second active material 20 may be efficiently achieved. More specifically, in the composite electrode 100 according to the present invention, most lithium ions may be diffused and moved into the first active material 10, and some lithium ions may be diffused and moved into the second active material 20. As a result, charging/discharging properties of the composite electrode 100 according to the present invention may be improved. In addition, by a subsequent pressurization process for manufacturing the composite electrode 100, the interface between the first active material 10 and the second active material 20 may be more closely formed.

Furthermore, as the composite electrode 100 includes the first active material 10 and the second active material 20, the composite electrode 100 may not include a solid electrolyte. Even when a solid electrolyte is not present in the composite electrode 100, by a close interfacial contact between the first active material 10 and the second active material 20, the conduction or storage of lithium ions may be efficiently achieved. That is, as the composite electrode 100 does not include a solid electrolyte, the composite electrode 100 may include the first active material 10 and the second active material 20 to a high content, and thus, may ultimately implement a secondary battery with a high capacity and a high energy density.

The composite electrode 100 may further include a polymeric binder (not shown). The polymeric binder may serve to physically or chemically bind the first active material 10 and the second active material 20. The content of the polymeric binder may be 1 wt % to 10 wt %, or 1 wt % to 5 wt % based on the total weight of the composite electrode 100.

For example, the polymeric binder may include at least one of polytetrafluoroethylene, polyvinylidene fluoride, poly(ethylene oxide), polyacrylonitrile, hydroxypropyl cellulose, carboxymethyl cellulose, styrene-butadiene, or nitrile-butadiene rubber.

In some embodiments, the composite electrode 100 may further include a lithium salt. By the lithium salt, lithium ion conduction properties of the composite electrode 100 may be further improved. For example, the lithium salt may include at least one of LiPF₆, LiBF₄, LiSbF₆, LiAsF₆, LiClO₄, LiN(C₂F₅SO₂)₂, LiN(CF₃SO₂)₂, CF₃SO₃Li, LiC(CF₃SO₂)₃, or LiC₄BO₈.

In some embodiments, the composite electrode 100 may further include an electro-conducting agent. Particularly, when the first active material 10 and the second active material 20 have a low electronic conductivity, the composite electrode 100 may include an electro-conducting agent. The electro-conducting agent may serve to impart electronic conductivity to the composite electrode 100, and by the electro-conducting agent, the electronic conduction properties of the composite electrode 100 may be improved. The content of the electro-conducting agent may be 1 wt % to 5 wt % based on the total weight of the composite electrode 100. The electro-conducting agent may include at least one of hard/soft carbon, carbon fiber, carbon nanotubes, linear carbon, carbon black, acetylene black, or Ketjen black.

The solid electrolyte layer 200 may be disposed between the composite electrodes 100. The solid electrolyte layer 200 may serve to transfer ions to the composite electrodes 100. The solid electrolyte layer 200 may include at least one of a sulfide-based solid electrolyte, an oxide-based solid electrolyte, or a polymer-based solid electrolyte. The sulfide-based solid electrolyte may include at least one of Li₄₋₋ₓGe₁₋ₓPₓS₄(LGPS), Li₃PS₄ glass-ceramic, Li₇P₃S₁₁ glass-ceramic (LPS), Li₄SnS₄, or Li₆PS₅X (X=I, Br, Cl). The oxide-based solid electrolyte may include at least one of Li₃ₓLa_{2/3-x□1/3-2x}TiO₃(LLTO), Li₁₊ₓTi₂₋ₓMₓ(PO₄)₃ (M=Al, Ga, In, Sc), or Li₇La₃Zr₂O₁₂(LLZO). The polymer-based solid electrolyte may include a gel electrolyte or a polymer electrolyte, and may be in a form in which a dissociated lithium salt is present in a polymer matrix. The polymer-based solid electrolyte may include at least one of polytetrafluoroethylene, polyvinylidene fluoride, poly(ethylene oxide), polyacrylonitrile, or hydroxypropyl cellulose. The lithium salt may include at least one of LiPF₆, LiBF₄, LiSbF₆, LiAsF₆, LiClO₄, LiN(C₂F₅SO₂)₂, LiN(CF₃SO₂)₂, CF₃SO₃Li, LiC(CF₃SO₂)₃, or LiC₄BO₈.

When the solid electrolyte layer 200 includes the sulfide-based solid electrolyte or the oxide-based solid electrolyte, the solid electrolyte layer 200 may further include a polymeric binder. By the polymeric binder, the mechanical stability of the solid electrolyte layer 200 may be further improved. For example, the polymeric binder may include at least one of polytetrafluoroethylene, polyvinylidene fluoride, poly(ethylene oxide), polyacrylonitrile, hydroxypropyl cellulose, carboxymethyl cellulose, styrene-butadiene, or nitrile-butadiene rubber.

The porosity of the composite electrode 100 may be 15 vol % or less. That is, in some embodiments, the composite electrode 100 may not include pores therein. According to the present invention, by minimizing pores in which lithium ions cannot migrate, it is possible to induce smooth lithium ion movement between active materials.

Referring back to FIG. 1, a method for manufacturing the all-solid-state secondary battery 1 according to an embodiment of the inventive concept will be described.

The composite electrode 100 may be formed in large quantities through a wet-based slurry process. The composite electrode 100 does not include a solid electrolyte (for example, a sulfide-based solid electrolyte having high reactivity, or an oxide-based solid electrolyte sensitive to interfacial properties), and thus, may be formed using a wider variety of slurry solvents and polymers. The slurry may include the first active material 10, the second active material 20, a polymeric binder, and a solvent. The slurry may be uniformly mixed through strong stirring. According to the solvent content in the slurry, the viscosity of the slurry may be adjusted to a viscosity (50 cP to 5000 cP) suitable for thickening a film.

After the mixing process of the slurry, a process of thickening a film may be performed to form the composite electrode 100. As an example, the process of thickening a film may include a doctor blade process. After the process of thickening a film, the solvent may be evaporated through a high-temperature drying process. The temperature of the high-temperature drying process may be set in consideration of the glass temperature of the polymeric binder, the melting point of the polymeric binder, the boiling point of the solvent, and the like, and a vacuum drying process may be performed for efficient evaporation of a solvent.

For a close interfacial contact between the first active material 10 and the second active material 20 in the composite electrode 100, a pressurization process may be formed on the composite electrode 100. As an example, the pressurization process may include a roll pressing process or a hydraulic pressing process. The pressure condition of the pressurization process may be 250 MPa or greater. For high conductivity of lithium ions of the composite electrode 100, it is preferable that a pressurization process of sufficient pressure is performed. In addition, in order to prevent volume contraction and expansion of the first and second active materials 10 and 20 during charging/discharging of the all-solid-state secondary battery 1, a pressure of 10 MPa or greater may be applied during the driving of the all-solid-state secondary battery 1.

### EXAMPLE 1

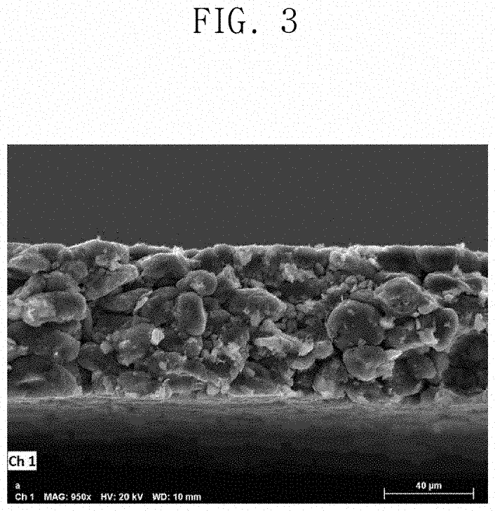

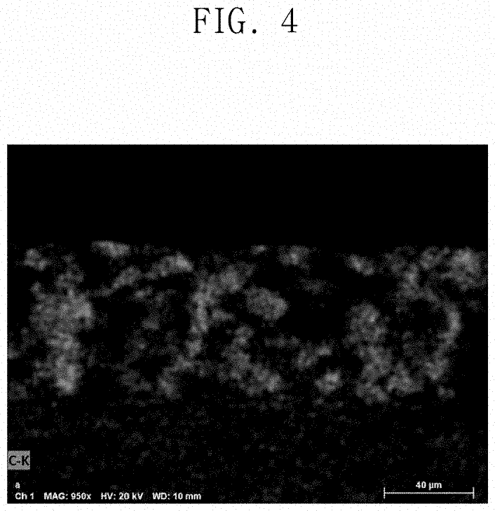

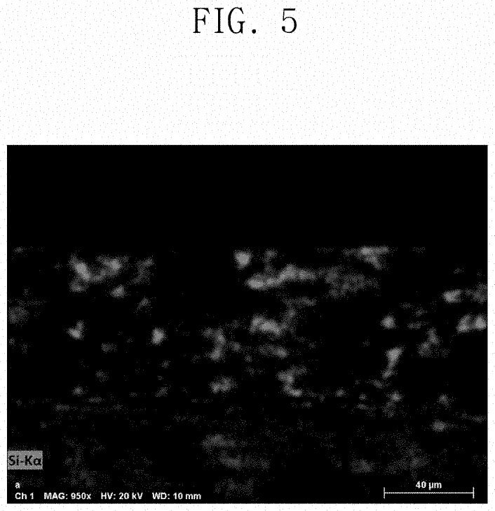

By using graphite as the first active material 10 and using silicon as the second active material 20, a composite electrode for an all-solid-state secondary battery was manufactured. Specifically, polyvinylidene fluoride was dissolved in methylpyrrolidone at 10 wt % and used as a polymeric binder. Graphite, silicon, and polyvinylidene fluoride were mixed to prepare slurry. The weight ratio of the graphite/silicon/polyvinylidene fluoride in the slurry was set to 88.2/9.8/2.0, and a solute was prepared on the basis of 10 g. For the uniform mixing of the slurry, a high-viscosity mixer (planetary mixer) was used to mix the slurry at 1500 rpm for 20 minutes. Methylpyrrolidone was additionally added to adjust a viscosity, and the viscosity of the slurry was set to about 500 cP. The thickness of the composite electrode was adjusted through the application thickness of a doctor blade, and converted into an electrode loading level to perform an electrode evaluation. The slurry was primarily dried in an atmospheric pressure oven of 120° C., and then the slurry was dried for 6 hours in a vacuum oven of 110° C. to remove a solvent remaining in the composite electrode. For a close interfacial contact between active materials, the composite electrode was pressurized at 350 MPa, and the SEM result of a finally obtained composite electrode is shown in FIG. 3, the EDS result for carbon of the composite electrode is shown in FIG. 4, and the EDS result for silicon of the composite electrode is shown in FIG. 5. Referring to FIG. 3 to FIG. 5, it can be confirmed that a graphite active material and a silicon active material are evenly mixed.

### Experimental Example 1

By using a lithium metal as a counter electrode of the composite electrode manufactured according to Example 1 and using Li₇P₃S₁₁ glass-ceramic (LPS) as a solid electrolyte membrane between the composite electrode and the counter electrode, a half-cell was manufactured. LPS particles were evenly applied, and then pressurized at 350 MPa to be prepared in the form of a pellet, and was integrated with the composite electrode manufactured according to Example 1. In order to prevent the intrusion of a solid electrolyte into the composite electrode, a pressurization process was performed on the composite electrode and the solid electrolyte, and then a pressurization process of 350 MPa was performed on a finally pressurized composite electrode and a solid electrolyte in the form of a pellet.

The loading level of the composite electrode manufactured according to Example 1 was 4.85 mg/cm². Based on the theoretical capacity of graphite and silicon (graphite: 372 mAh/g, silicon: 4,200 mAh/g), the theoretical capacity per weight of the composite electrode manufactured according to Example 1 was calculated to be 739.7 mAh/g, and based thereon, 0.1 C-rate charging/discharging was performed.

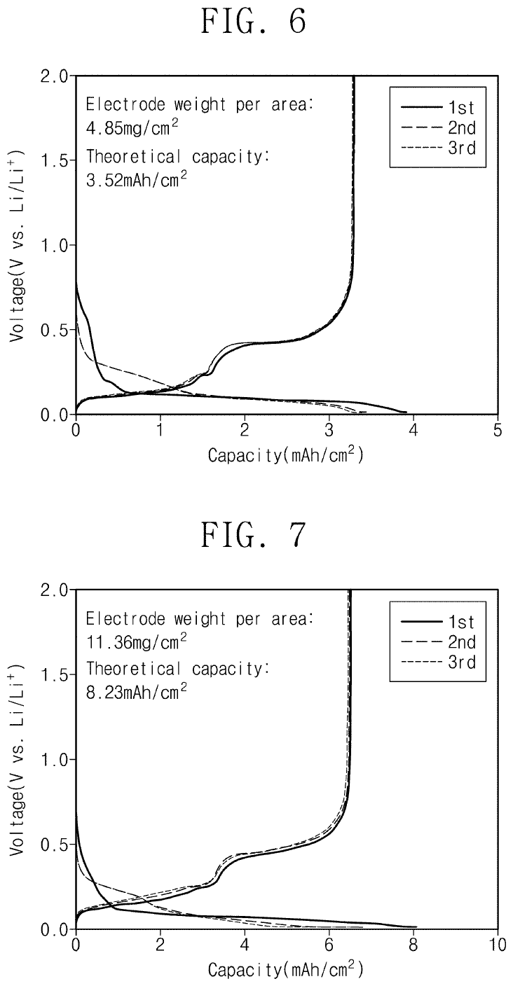

The charging/discharging evaluation of the composite electrode was performed at 60° C. The voltage cut-off condition was set to 2.0 V to 0.01 V. The reference discharging condition of the half-cell of graphite/silicon-lithium metal was configured to proceed primary discharging until 0.01 V based on a constant current, and to add a constant voltage condition maintaining 0.01 V until ⅕ of an initial current. The charging condition was to proceed charging until 2 V based on a constant current. The measurement was performed 3 times based on 0.1 C-rate, and the result of measuring charging/discharging properties is shown in FIG. 6.

The loading level of the composite electrode of Example 1 was 4.85 mg/cm², and graphite and silicon respectively have a weight per area of 4.28 mg/cm² and 0.48 mg/cm² and may theoretically contribute to the total theoretical capacity by 1.59 mAh/cm² and 2.00 mAh/cm², respectively. Since the capacity measured in Experimental Example 1 was 3.28 mAh/cm², it can be confirmed that the theoretical capacity (1.59 mAh/cm²) which graphite may implement was exceeded. From the result, it can be seen that a substantial portion of the measured capacity originates from silicon, and it can be confirmed that lithium ions diffuse from graphite to silicon, thereby contributing to charging/discharging properties.

### EXAMPLE 2

A graphite/silicon composite electrode was manufactured in the same manner as in Example 1 except that the composite electrode was manufactured to have a weight of 11.36 mg/cm² relative to area.

### Experimental Example 2

By using the composite electrode manufactured according to Example 2, a charging/discharging evaluation was performed by substantially the same method as in Experiment Example 1, and the result of measuring charging/discharging properties is shown in FIG. 7.

The loading level of the composite electrode of Example 2 was 11.36 mg/cm², and graphite and silicon respectively have a weight per area of 10.02 mg/cm² and 1.11 mg/cm² and may theoretically contribute to the total theoretical capacity by 3.73 mAh/cm² and 4.68 mAh/cm², respectively. Since the capacity measured in Experimental Example 2 was 6.53 mAh/cm², it can be confirmed that the theoretical capacity (3.73 mAh/cm²) which graphite may implement was exceeded. From the result, it can be seen that a substantial portion of the measured capacity originates from silicon, and it can be confirmed that lithium ions diffuse from graphite to silicon, thereby contributing to charging/discharging properties.

### EXAMPLE 3

A graphite/silicon composite electrode was manufactured in the same manner as in Example 1 except that the composite electrode was manufactured to have a weight of 16.97 mg/cm² relative to area.

### Experimental Example 3

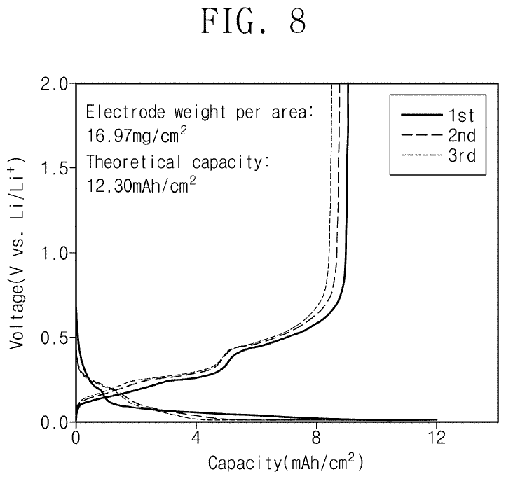

By using the composite electrode manufactured according to Example 3, a charging/discharging evaluation was performed by substantially the same method as in Experiment Example 1, and the result of measuring charging/discharging properties is shown in FIG. 8.

The loading level of the composite electrode of Example 3 was 16.97 mg/cm², and graphite and silicon respectively have a weight per area of 14.97 mg/cm² and 1.66 mg/cm² and may theoretically contribute to the total theoretical capacity by 5.57 mAh/cm² and 6.98 mAh/cm², respectively. Since the capacity measured in Experimental Example 3 was 8.78 mAh/cm², it can be confirmed that the theoretical capacity (5.57 mAh/cm²) which graphite may implement was exceeded. From the result, it can be seen that a substantial portion of the measured capacity originates from silicon, and it can be confirmed that lithium ions diffuse from graphite to silicon, thereby contributing to charging/discharging properties.

Through Experimental Example 1 to Experimental Example 3, it can be confirmed that the diffusion of lithium ions between active materials in the composite electrode of each of Example 1 to Example 3 is efficiently achieved. As a result, according to the present invention, a composite electrode for an all-solid-state secondary battery having a high energy density may be implemented.

A composite electrode for an all-solid-state secondary battery according to the present invention includes two or more types of active materials having different mechanical and electrochemical properties, so that it is possible to implement a composite electrode with maximized energy density, and ultimately implement an all-solid-state secondary battery with improved capacity and stability.

The composite electrode for an all-solid-state secondary battery according to the present invention does not include a solid electrolyte having high reactivity in a composite electrode, so that processability may be improved.

Although the present invention has been described with reference to the accompanying drawings, it will be understood by those having ordinary skill in the art to which the present invention pertains that various changes in form and details may be made therein without departing from the spirit and scope of the present invention. Therefore, it is to be understood that the above-described embodiments are exemplary and non-limiting in every respect.

What is claimed is:

1. A composite electrode for an all-solid-state secondary battery, the composite electrode comprising a first active material and a second active material,
wherein the first active material and the second active material include different materials from each other, and
the content of the first active material is 50 vol % to 98 vol % based on the total volume of the first active material and the second active material,
the first active material has a volume change rate of 0 vol % to 30 vol % according to volume expansion/contraction during a charging/discharging process, and
the second active material has a volume change rate of 35 vol % to 1000 vol % according to volume expansion/contraction during a charging/discharging process.

2. The composite electrode for an all-solid-state secondary battery of claim 1, wherein the composite electrode has a porosity of 15 vol % or less.

3. The composite electrode for an all-solid-state secondary battery of claim 1, wherein the first active material comprises at least one of a carbon-based material and a sulfide-based material.

4. The composite electrode for an all-solid-state secondary battery of claim 1, wherein the first active material comprises at least one of natural graphite, artificial graphite, carbon nanotubes, carbon oxide nanotubes, graphene, graphene oxide, carbon fiber, amorphous carbon, highly oriented pyrolytic graphite (HOPG), titanium disulfide (TiS₂), lithium titanium disulfide, molybdenum disulfide (MoS₂), lithium molybdenum disulfide, tungsten disulfide (WS₂), lithium tungsten disulfide, iron sulfide (FeS₂), lithium iron sulfide, vanadium disulfide (VS₂), lithium vanadium disulfide, and LiTi₂(PS₄)₃.

5. The composite electrode for an all-solid-state secondary battery of claim 1, wherein the second active material comprises at least one of a metal-based material, an oxide-based material, a phosphide-based material, a phosphate-based material, a silicon-based material, and a halogen-based material.

6. The composite electrode for an all-solid-state secondary battery of claim 1, wherein the second active material comprises at least one of Sn, Li, Al, Ag, Bi, In, Ge, Pb, Pt, Ti, Zn, Mg, Co, a lithium-nickel-cobalt-aluminum-based oxide (LiNiₓCo_{y}Al_{z}O₂, 0.01≤x≤2, 0.01≤y≤0.30, 0.01≤z≤0.99), a lithium-cobalt-based oxide (LiCoO₂), a lithium-nickel-based oxide (LiNiO₂), a lithium-manganese-based oxide (LiMn₂O₄), a lithium-nickel-cobalt-manganese-based oxide (LiNiₓCo_{y}Mn_{z}O₂, x+y+z=1), a lithium-iron-phosphorus-based oxide (LiFePO₄), a lithium-titanium-based oxide (Li₄Ti₅O₁₂), a metal oxide, Si, a lithium-silicon alloy, SiN, SiOₓ (0.01≤x≤2), AgF, CuF, BiF₃, CuF₂, CoF₃, FeF₃, NiF₂, MnF₃, FeF₂, VF₃, TiF₃, CuCl₂, FeCl₃, and MnCl₂.

7. The composite electrode for an all-solid-state secondary battery of claim 6, wherein the metal oxide comprises an oxide containing at least one metal among Sn, Li, Al, Ag, Bi, In, Ge, Pb, Pt, Ti, Zn, Mg, and Co.

8. The composite electrode for an all-solid-state secondary battery of claim 1, wherein the composite electrode further comprises a polymeric binder, and
wherein a content of the polymeric binder is 1 wt % to 5 wt % based on the total weight of the composite electrode.

9. The composite electrode for an all-solid-state secondary battery of claim 8, wherein the polymeric binder comprises at least one of polytetrafluoroethylene, polyvinylidene fluoride, poly(ethylene oxide), polyacrylonitrile, hydroxypropyl cellulose, carboxymethyl cellulose, styrene-butadiene, and nitrile-butadiene rubber.

10. The composite electrode for an all-solid-state secondary battery of claim 1, wherein the composite electrode further comprises an electro-conducting agent, and
wherein a content of the electro-conducting agent is 1 wt % to 5 wt % based on the total weight of the composite electrode.

11. The composite electrode for an all-solid-state secondary battery of claim 10, wherein the electro-conducting agent comprises at least one of hard/soft carbon, carbon fiber, carbon nanotubes, linear carbon, carbon black, acetylene black, and Ketjen black.
